(19) United States
(12) Patent Application Publication
(10) Pub. No.: US 2006/0006738 A1
(43) Pub. Date: Jan. 12, 2006

(54) Device and method for the redundant voltage supply of safety-relevant systems

(75) Inventors: Gerald Faulhaber, Wannweil (DE); Peter Hanf, Gammelshausen (DE); Andreas Pohlmann, Weil der Stradt (DE)

Correspondence Address: FITCH, EVEN, TABIN & FLANNERY, P. O. BOX 65973, WASHINGTON, DC, 20035, US

(73) Assignee: DAIMLERCHRYSLER AG, STUTTGART (DE)

(21) Appl. No.: 10/522,881

(22) PCT Filed: Jul. 17, 2003
(86) PCT No.: PCT/EP03/07757

§ 371 Date: Jul. 22, 2005

(30) Foreign Application Priority Data
Aug. 3, 2002 (DE) 102 35 527.4

(51) Int. Cl. B60L 1/00

(52) U.S. Cl. 307/10.1

(57) ABSTRACT

The present invention discloses a device and a method for the redundant voltage supply of safety-relevant systems, in particular in motor vehicles. Both a failure of a voltage supply to safety-relevant systems is detected and a switchover to another voltage supply is initiated in response to this, and it is also ensured that even if one or two drive devices for switching over the voltage fail, a fallback level is available which then switches over the voltage. This ensures, both if a voltage supply to safety-relevant systems fails and if drive devices fail, that voltage is nevertheless switched over and in this way the availability of safety-relevant systems is considerably improved.

The invention relates to a device and a method for the redundant voltage supply of safety-relevant systems, in particular in motor vehicles.

To date, various systems with a redundant voltage supply have been proposed for ensuring the supply to safety-relevant systems, in particular in motor vehicles.

WO 99/42331 discloses a voltage-supply circuit for safety-relevant systems, for example electric brakes, in motor vehicles, in which circuit the systems have their own associated additional batteries which can be connected to a battery of a vehicle electrical system and/or to the generator using a charging circuit and switchover unit and via means for monitoring and distributing the electric power. In normal operation, the safety-relevant systems are supplied from their associated additional battery, a switchover is made if there is fault with the additional battery or if the additional battery is excessively discharged, and the safety-relevant systems are supplied directly from the battery of the vehicle electrical system. On account of this switchover to the battery of the vehicle electrical system if there is no longer sufficient power in the additional battery, there is no need for a monitoring circuit for the additional battery.

Furthermore, DE 100 53 584 A1 discloses a redundant voltage supply for safety-relevant loads. This device has a first voltage supply, which is arranged in the vehicle electrical system, and a second voltage supply, the first and second voltage supplies being connected by a decoupling element. The decoupling element, for example a diode, a switch with current-direction detection or field-effect transistors with internal short circuit-current detection, ensures a directed flow of current from the first to the second voltage supply. In addition, the first voltage supply, a second decoupling element and the second voltage supply are connected to the safety-relevant load by means of a third decoupling element and ensure a directed flow of current. If the voltage of the first voltage supply falls below that of the second voltage supply, voltage is transmitted through the decoupling element, with the result that the second voltage supply takes over the function of supplying voltage to the safety-relevant load.

Finally, DE 198 55 245 A1 specifies a redundant voltage supply for electrical loads in a vehicle electrical system which is used, in particular, in electrically operated brakes. In order to ensure the voltage supply, the electrical load is simultaneously connected to two separate voltage paths via disconnecting modules, said voltage paths each being connected to a dedicated voltage store via charge-disconnecting modules. If a fault, which endangers the voltage supply for the load, occurs in one supply path, this supply path is opened by means of suitable switching means and the function of supplying voltage is taken over solely by the voltage path which is operational. Disconnecting modules and charge-disconnecting modules can be integrated in a battery connector.

The prior art described above thus provides various solutions for improving the fail-safety of safety-relevant systems, to be precise in the event of a failure of the voltage supply, as a result of which, for example, a braking or steering action would no longer be available without a fallback level in the case of an electrohydraulic brake (EHB), an electrohydraulic steering system (EHL) etc., by switching over to a back-up power supply.

However, these conventional embodiments do not contain a safety function which could also compensate for a failure of the drive logic which likewise may also lead to a complete failure of safety-relevant systems, for example of the electrohydraulic brake (EHB), the electrohydraulic steering system (EHL) etc., since a switchover in the event of a voltage failure is then no longer possible. To be precise, specific voltages in the vehicle are usually made available to the vehicle electrical system by means of driven relays and are driven exclusively.

It is therefore the object of the present invention to design a device for the redundant voltage supply of safety-relevant systems with which both a failure of the voltage supply and a failure of the drive logic for switching over in the event of a failure of the voltage supply can be compensated for in a simple and cost-effective manner.

This object is achieved by a device for the redundant voltage supply of safety-relevant systems which has the features of claim 1 and by a method for the redundant voltage supply of safety-relevant systems which has the features of claim 3.

In the device according to the invention and in the method according to the invention, both monitoring of whether different voltages are present across safety-relevant systems and monitoring of whether a first drive device and/or a second drive device has/have switched on a voltage are thus carried out as the first fallback level, and if the first and second drive devices fail, a third drive device switches on the voltage.

In this way, the availability of the voltage supply increases on ignition “on” and a considerable increase in the fail-safety as a result of the formation of two fallback levels which can likewise perform the switchover.

Furthermore, the device according to the invention for the redundant voltage supply of safety-relevant systems represents an extremely cost-effective solution since the individual drive devices for driving exclusive relays for one voltage supply in each case are already present in conventional devices and all that is additionally required is to provide the connection and the exchange of information via communication channels, for example the CAN bus, and to make it possible for each of the drive devices to drive all of the relays.

These and further objects, features and advantages of the invention are explained in more detail below with reference to the drawing, in which:

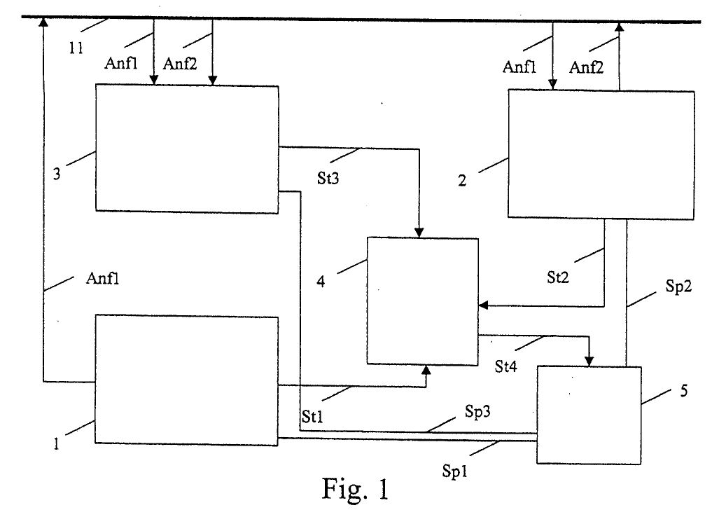

FIG. 1 is a simplified block diagram of the device according to the invention for the redundant voltage supply of safety-relevant systems, and

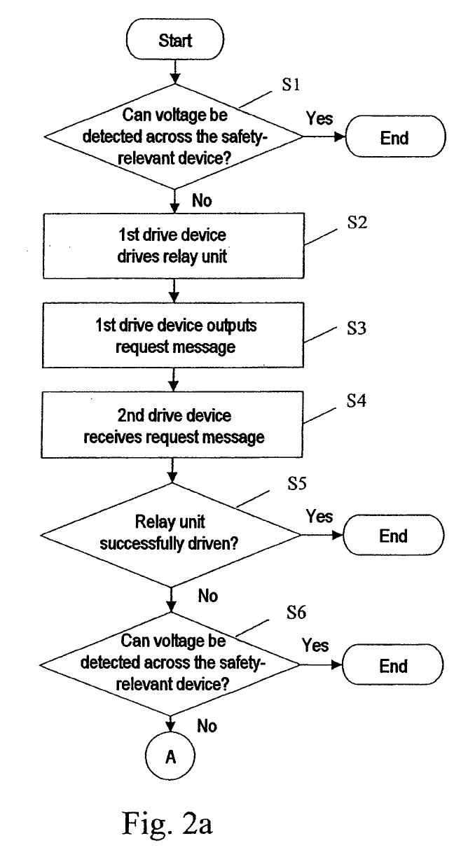

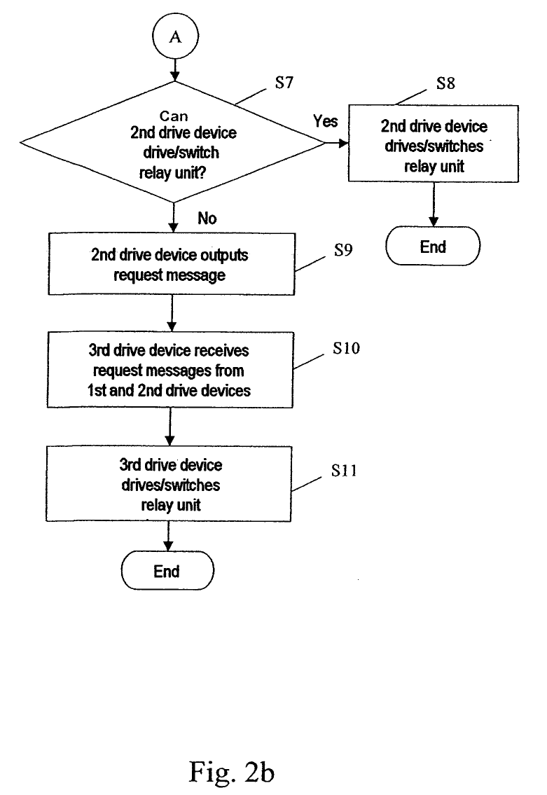

FIG. 2, which consists of FIGS. 2a and 2b, is a flowchart which illustrates the functional sequence of the method according to the invention for the redundant voltage supply of safety-relevant systems.

The following text firstly describes in more detail the simplified structure of the device according to the invention for the redundant voltage supply with reference to FIG. 1.

In FIG. 1, 11 denotes a CAN bus as an example of communication channels via which communication signals are transmitted. The device according to the invention for the redundant voltage supply has a first drive device 1 which monitors for the presence of a voltage across one or more safety-relevant system or systems 5 via a line Sp1 and, if no voltage is present there, can drive one or more relays contained in a relay unit 4 by means of a control signal St1, so that a voltage is then applied to the safety-relevant system or systems 5 again. In addition, the first drive device 1 outputs a request message Anf1 to the CAN bus 11 if one or more relays in the relay unit 4 is to be driven in order to re-establish a voltage supply to the safety-relevant system or systems 5. These relays of the relay unit 4 switch on and off a voltage supply for safety-relevant electrical systems 5, for example an electrohydraulic brake (EHB), an electrohydraulic steering system (EHL) etc.

Furthermore, the device according to the invention comprises a second drive device 2 which monitors for the presence of a voltage across one or more safety-relevant system or systems 5 via a line Sp2 and, if no voltage is present there, can likewise drive the relays in the relay unit 4. If the second drive device 2 receives the request message Anf1 from the first drive device 1 via the CAN bus 11, it checks whether the first drive device 1 has initiated switching of the relay unit 4, that is to say whether the voltage supply of the one or more safety-relevant systems 5 has been re-established. If the relay unit 4 has not switched and in addition it is determined via line Sp2 that no voltage is applied to the safety-relevant system or systems 5, the second drive device drives the relay or relays in the relay unit 4 in order to re-establish a voltage supply. The second drive device 2 is also designed in such a way that it sends a request message Anf2 to the CAN bus 11 if it cannot switch the relay or relays in the relay unit 4 despite the absence of voltage across the safety-relevant system or systems 5.

In addition to these two first and second drive devices 1 and 2, there is also a third drive device 3 which monitors for the presence of a voltage across one or more safety-relevant system or systems 5 via a line Sp3 and, if no voltage is present there, can likewise drive the relays in the relay unit 4. If the drive device 3 receives both a request message Anf1 from the first drive device 1 and a request message Anf2 from the second drive device 2 via the CAN bus and detects the absence of a voltage across the safety-relevant system or systems 5, the drive device 3 drives the relay unit 4 in such a manner that the relay or relays are/is switched over, so that a voltage supply to the safety-relevant system or systems 5 is re-established.

The method according to the invention for the redundant voltage supply of safety-critical systems is explained in greater detail in the text which follows with reference to FIG. 2, which consists of FIGS. 2a and 2b.

Initially, in step 1, the drive device 1 monitors via a line Sp1 whether a voltage can be detected across one or more safety-relevant systems 5. If this is the case, the sequence is terminated and returns to the start (monitoring) again.

If it is determined in step S1 that no voltage is applied to one or more safety-relevant systems 5, in step S2 the first drive device 1 drives the relay unit 4 by means of a control signal St1 so that a voltage is again applied to the safety-relevant system or systems. Otherwise, the sequence ends after step S1.

Subsequently, in step S3, a request message Anf1, which states that it is necessary to switch over the relay in order to supply voltage, is output to the CAN bus 11. This request message Anf1 is received by the second drive device 2 in step S4. Following this, the second drive device 2 checks in step S5 whether the first drive device 1 has successfully driven/switched over the relay unit 4. If this is the case, the sequence ends. Otherwise, the sequence proceeds to step S6, in which it is determined via a line Sp2 whether a voltage is applied to one or more safety-relevant systems 5. In the affirmative, the sequence ends, and in the negative case, the sequence proceeds to step S7, in which a check is made as to whether it is possible for the second drive unit 2 to drive/switch the relay unit 4. If driving/switching is judged to be possible in step S7, then in step S8 the second drive device 2 drives/switches the relay unit 4 by means of the control signal St2 and then the sequence ends.

If it is not possible for the second drive device 2 to drive/switch the relay unit 4 for whatever reasons, for example due to an interruption in the line for the control signal St2, the second drive device 2 outputs, in a step S9, a request message Anf2 to the CAN bus 11. In step S10, the third drive device 3 receives this request message Anf2 from the second drive device 2 together with the request message Anf1 from the first drive device 1. This is followed in step S11 by the third drive device 3 driving/switching the relay unit 4 by means of a control signal St3. The sequence then ends.

The above-described device according to the invention and the method for the redundant voltage supply of safety-relevant systems is cost-effective to implement since the individual drive devices for driving exclusive relays for one voltage supply in each case are already present in conventional devices and all that is additionally required is to provide the connection and the exchange of information via the CAN bus, as one example of communication channels, for example also control lines, LIN etc., and to make it possible for each of the drive devices to drive all of the relays.

In this way, a reliable device and a method for the redundant voltage supply of safety-relevant systems can be realized in a straightforward and cost-effective manner, without a large amount of additional outlay on circuitry and components.

Here, the advantage of the device according to the invention and of the method for the redundant voltage supply of safety-relevant systems is the double redundancy for switching the relays. Ensuring the provision of special-purpose voltage supplies leads to a higher availability level of safety-critical systems.

It goes without saying that a person skilled in the art may, in place of the three drive devices used in the preferred exemplary embodiment, also use more drive devices or in each case 3 drive devices from amongst the multiplicity of drive devices in the vehicle for relays.

1. A device for the redundant voltage supply of safety-relevant systems, in particular in motor vehicles, having:
at least one first drive device (1), one second drive device (2) and one third drive device (3), each of these drive devices being designed to drive relays in a relay unit (4) for switching over voltage supplies of safety-relevant systems (5), characterized in that
the drive devices (1, 2, 3) are connected to a communication channel (11),
the first and second drive devices (1, 2) each have a device for monitoring a voltage applied to the safety-relevant systems (5),
the first drive device (1) can trigger a switching process of the relay unit (4) and output a request message (Anf1) to the communication channel (11) if the device for monitoring a voltage applied to the safety-relevant systems (5) detects that no voltage is applied;
the second drive device (2) has a device for checking whether the first drive device has driven and switched the relay unit (4), and, if the device for checking determines that the first drive device has not driven or has not switched the relay unit, and the device for monitoring a voltage applied to the safety-relevant systems (5) detects that no voltage is applied, said second drive device can trigger a switching process of the relay unit (4) and, if it is not possible to trigger a switching process of the relay unit (4), can output a further request message (Anf2) to the communication channel (11),
and
the third drive device (3) can receive from the communication channel (11) the request messages (Anf1, Anf2) from the first and second drive devices (1, 2) and can trigger a switching process of the relay unit (4) when both request messages (Anf1, Anf2) are received.

2. The device as claimed in claim 1, characterized in that
another unit for switching over voltages can also be used in place of the relay unit (4) having relays.

3. The device as claimed in claim 2 characterized in that the communication channel (11) is a CAN bus.

4. A method for the redundant voltage supply of safety-relevant systems, in particular in motor vehicles, characterized by the steps:
(S1) a first drive device (1) monitors via a first line (Sp1) whether a voltage can be detected across one or more safety-relevant systems (5); return to the start if this is the case;
(S2) if it is determined in step S1 that no voltage is applied to one or more safety-relevant systems (5), the first drive device (1) drives a relay unit (4) by means of a first control signal (St1) so that a voltage is again applied to the safety-relevant system or systems (5);
(S3) the first drive device (1) outputs to a communication channel (11) a first request message (Anf1) which states that it is necessary to switch over at least one relay of the relay unit (4) in order to supply voltage;
(S4) the second drive device (2) receives the first request message (Anf1);
(S5) the second drive device (2) checks whether the first drive device (1) has successfully driven/switched over the relay unit (4); return to the start if this is the case;
(S6) the second drive device (2) determines via a second line (Sp2) whether a voltage is applied to one or more safety-relevant systems (5); return to the start in the affirmative;
(S7) check whether it is possible for the second drive device (2) to drive/switch the relay unit (4) in the negative case;
(S8) the second drive device (2) drives/switches the relay unit (4) by means of a second control signal (St2) if driving/switching is judged to be possible in step S7, then return to the start;
(S9) the second drive device (2) outputs a second request message (Anf2) to the communication channel (11) if it is not possible for the second drive device (2) to drive/switch the relay unit (4) for whatever reasons, for example due to an interruption in the line for the second control signal;
(S10) the third drive device (3) receives the second request message (Anf2) from the second drive device (2) together with the first request message (Anf1) from the first drive device (1);
(S11) the third drive device (3) drives/switches the relay unit (4) by means of a third control signal (St3); then return to the start.

5. The device as claimed in claim 1 characterized in that the communication channel (11) is a CAN bus.
